(19) United States
(12) Patent Application Publication
(10) Pub. No.: US 2025/0326674 A1
(43) Pub. Date: Oct. 23, 2025

(54) SYSTEM AND METHOD FOR SIMULTANEOUSLY FORMING AND IMPROVING ANTI-REFLECTIVE AND ANTI-GLARE BEHAVIOR OF A GLASS ARTICLE

(71) Applicant: CORNING INCORPORATED, CORNING, NY (US)

(72) Inventors: Venkatesh Botu, Corning, NY (US); Attila Lang de Falussy, Elmira, NY (US); John Robert Saltzer, Jr., Beaver Dams, NY (US); James Patrick Trice, Corning, NY (US); Krista Lynn Brown, Painted Post, NY (US)

(21) Appl. No.: 18/871,039

(22) PCT Filed: Jun. 2, 2023
(86) PCT No.: PCT/US2023/024263

§ 371 Date: Dec. 2, 2024

Related U.S. Application Data
(60) Provisional application No. 63/350,485, filed on Jun. 9, 2022.

(51) Int. Cl. C03B 23/023; B32B 17/06; C03C 15/00

(52) U.S. Cl. CPC C03B 23/023; B32B 17/06; C03C 15/00; B32B 2250/02

(57) ABSTRACT

A method of forming a shaped glass laminate having improved anti-reflection (AR) and anti-glare (AG) characteristics, including preheating a substrate including a core layer and at least one cladding layer, the at least one cladding layer including a phase-separable glass composition, simultaneously heat treating and thermal forming the substrate such that the at least one cladding layer is phase-separated and at least a portion of the substrate is deformed to form the shaped glass laminate, the simultaneous heat treating and thermal forming of the substrate including heating the substrate and pressing the substrate at the same time, and etch treating the substrate.

### BACKGROUND OF THE DISCLOSURE

### Cross-Reference to Related Applications

This application claims the benefit of priority under 35 U.S.C. § 119 of U.S. Provisional Application No. 63/350,485 filed Jun. 9, 2022, the content of which is incorporated herein by reference to its entirety.

### FIELD OF THE INVENTION

The present disclosure relates to anti-reflection (AR) and anti-glare (AG) glass laminates with improved optical performance and methods for making the same.

### DESCRIPTION OF RELATED ART

Traditional anti-reflective (AR) coatings consist of either a single layer or a stack of multiple low and high index materials that work to destructively interfere different reflections from the stack. Current AR coatings that have satisfactory anti-reflection qualities across the visible wavelength range or beyond require multiple different coatings. Anti-glare (AG) treatments work by scattering the incoming light away from specular directions. This is commonly achieved by patterning the surface with etching, textured coatings, or bulk scatterers. However, such AR coating and AG treatment processes substantially add to the cost of the base glass article.

### BRIEF SUMMARY OF THE DISCLOSURE

In view of the foregoing, it is an object of the present disclosure to provide an apparatus and method for simultaneously thermal forming and improving the AR and AG behavior of a glass article.

An exemplary embodiment of the present disclosure provides a method of forming a shaped glass laminate, comprising preheating a substrate including a core layer and at least one cladding layer, the at least one cladding layer comprising a phase-separable glass composition, simultaneously heat treating and thermal forming the substrate such that the at least one cladding layer is phase-separated and at least a portion of the substrate is deformed to form the shaped glass laminate, the simultaneous heat treating and thermal forming of the substrate including heating the substrate and pressing the substrate at the same time, and etch treating the substrate.

In some embodiments, the step of simultaneously heat treating and thermal forming the substrate further comprises cooling the substrate. In some embodiments, the step of preheating the substrate comprises heating the substrate to a temperature of less than a glass transition temperature of the at least one cladding layer. In some embodiments, the step of preheating the substrate comprises heating the substrate using a plurality of preheat stages, each preheat stage comprising a preheat temperature range and preheat hold time. In some embodiments, the step of simultaneously heat treating and thermal forming the substrate comprises heating the substrate to a temperature ranging from a glass transition temperature of the at least one cladding layer to a softening point of the at least one cladding layer, and applying a pressure of at least 0.9 MPa to the substrate.

In some embodiments, the step of simultaneously heat treating and thermal forming the substrate comprises simultaneously heating the substrate to about 750° C. and applying a pressure of about 0.9 MPa to the substrate for at least 600 seconds. In some embodiments, the step of simultaneously heat treating and thermal forming the substrate comprises simultaneously heating the substrate at about 750° C. and applying a pressure of about 0.9 MPa to the substrate on a forming surface for at least 1200 seconds. In some embodiments, the step of simultaneously heat treating and thermal forming the substrate comprises simultaneously heating the substrate at a temperature of greater than or equal to about 710° C. and contacting the substrate with a forming surface at a pressure ranging between 0.1 MPa to 0.9 MPa. In some embodiments, the step of simultaneously heat treating and thermal forming the substrate comprises simultaneously heating the substrate to a temperature at which spinodal phase separation of the at least one cladding layer occurs and contacting the substrate with a forming surface at a pressure at which deformation of the substrate occurs.

The method as recited in claim 10, wherein the forming surface comprises a pre-form mold. In some embodiments, the step of cooling the substrate comprises cooling the substrate using a plurality of cooling stages, each cooling stage comprising a cooling temperature range, a pressure, and a cooling hold time. In some embodiments, the step of etch treating the substrate comprises applying a solution of at least 2% vol. hydrogen fluoride (HF) to the substrate for at least 90 seconds, submerging the substrate in a dihydrogen monoxide (H₂O) bath for at least 120 seconds, rinsing the substrate in deionized water, and cleaning the substrate with dinitrogen (N₂).

Another exemplary embodiment of the present disclosure provides a method of forming a phase-separated glass laminate having improved anti-reflection (AR) and anti-glare (AG) characteristics, the method comprising providing a substrate including a core layer and at least one cladding layer fused with the core layer, simultaneously heat treating and forming the substrate, using a thermal press, by heating the substrate to a temperature at which spinodal phase separation of the at least one cladding layer occurs, and pressing the substrate onto a forming surface, and etch treating the substrate.

In some embodiments, the step of heating the substrate to a temperature at which spinodal phase separation of the at least one cladding layer occurs comprises heating the substrate to a temperature ranging from a glass transition temperature of the at least one cladding layer to a softening point of the at least one cladding layer for at least 1200 seconds. In some embodiments, the step of pressing the substrate onto the forming surface comprises arranging the substrate on a pre-form mold, and applying a first pressure to the substrate of at least 0.9 MPa for at least 1200 seconds. In some embodiments, the method further comprises reducing the first pressure applied to the substrate from 0.9 MPa to a second pressure ranging between 0.1 MPa to 0.4 MPa. In some embodiments, the method further comprises, prior to the step of simultaneously heat treating and forming the substrate, preheating the substrate to a temperature of less than a glass transition temperature of the at least one cladding layer.

Another exemplary embodiment of the present disclosure provides a method of forming and shaping a phase-separated glass laminate having improved anti-reflection (AR) and anti-glare (AG) characteristics, comprising providing a substrate including a core layer and at least one cladding layer, simultaneously heat treating and forming the substrate, using a thermal press, by preheating the substrate to a first temperature, heating the substrate to a second temperature, greater than the first temperature, at which spinodal phase separation of the at least one cladding layer occurs while pressing the substrate into a forming surface at a first pressure to permanently deform the substrate, and cooling the substrate to a third temperature, less than the second temperature, while pressing the substrate into the forming surface at a second pressure, less than the first pressure, and etch treating the substrate.

In some embodiments, the step of simultaneously heat treating and forming the substrate further comprises cooling the substrate to a fourth temperature, less than the third temperature, while pressing the substrate into the forming surface at a third pressure, less than the second pressure. In some embodiments, the second temperature is in a range of 710° C. to 750° C., and the first pressure is greater than 0.4 MPa.

Another exemplary embodiment of the present disclosure provides a shaped glass laminate article comprising a core layer, at least one cladding layer fused to the core layer, the at least one cladding layer including a porous region at an outer surface thereof, the core layer and the at least one cladding layer being deformed to form the shaped glass laminate, wherein the shaped glass laminate article has a transmittance across an entire spectrum from about 400 nm to about 2200 nm that is greater than 98%, and the shaped glass laminate article has a reflectance across an entire spectrum from 400 nm to 2200 nm that is less than 1% for one surface of the shaped glass laminate article. In some embodiments, a thickness of the porous region has a percent deviation of less than 12 percent.

In some embodiments, the porous region has an average pore size that is greater than or equal to 10 nm and less than or equal to 200 nm. In some embodiments, the porous region has an average pore size that is greater than or equal to 20 nm and less than or equal to 150 nm. In some embodiments, the porous region has a porosity that is greater than or equal 0.16 and less than or equal to 0.22. In some embodiments, a thickness of the porous region is greater than or equal to 350 nm and less than or equal to 450 nm. In some embodiments, a thickness of the porous region is greater than or equal to 375 nm and less than or equal to 400 nm.

Another exemplary embodiment of the present disclosure provides a shaped glass laminate article comprising a core layer, at least one cladding layer fused to the core layer, the at least one cladding layer including a porous region at an outer surface thereof, the core layer and the at least one cladding layer being deformed to form the shaped glass laminate, wherein the shaped glass laminate article has a transmittance across an entire spectrum from about 400 nm to about 2200 nm that is greater than or equal to 97%, and the shaped glass laminate article has a reflectance across an entire spectrum from 400 nm to 2200 nm that is less than or equal to 3% at the outer surface.

In some embodiments, the shaped glass laminate article has a transmittance across the entire visible spectrum from about 400 nm to about 2200 nm that is greater than 98%. In some embodiments, the shaped glass laminate article has a reflectance across the entire visible spectrum from about 400 nm to about 2200 nm that is less than 1%. In some embodiments, the porous region has an average pore size that is greater than or equal to 10 nm and less than or equal to 200 nm. In some embodiments, the porous region has a porosity that is greater than or equal 0.16 and less than or equal to 0.22. In some embodiments, a thickness of the porous region is greater than or equal to 350 nm and less than or equal to 450 nm. In some embodiments, a thickness of the porous region has a percent deviation of less than 12 percent.

The following will describe embodiments of the present disclosure, but it should be appreciated that the present disclosure is not limited to the described embodiments and various modifications of the disclosure are possible without departing from the basic principles. The scope of the present disclosure is therefore to be determined solely by the appended claims.

### BRIEF DESCRIPTION OF THE SEVERAL VIEWS OF THE DRAWINGS

Various embodiments are disclosed, by way of example only, with reference to the accompanying schematic drawings below in which corresponding reference symbols indicate corresponding parts.

FIG. 1 is a cross-sectional view of an exemplary glass article.

FIG. 2 is a cross-sectional view of an exemplary overflow distributor that can be used to form an exemplary glass article.

FIG. 3 illustrates an exemplary fusion-drawn laminated glass treatment process.

FIG. 4A is a top elevational view of an exemplary pre-form before forming.

FIG. 4B is a top elevational view of the exemplary pre-form shown in FIG. 4A, after forming.

FIG. 4C is a cross-sectional view of the exemplary pre-form mold taken generally along line 4C-4C in FIG. 4B.

FIG. 5 shows a graph illustrating an exemplary embodiment of a method of manufacturing an exemplary glass article.

FIG. 6 shows a chart including data related to the graph shown in FIG. 5.

FIG. 7 shows a graph illustrating the transmittance for glass articles formed by various methods across different wavelengths.

FIG. 8 shows a graph illustrating the reflectance for glass articles formed by various methods across different wavelengths.

FIG. 9 is a perspective view of a glass article.

FIG. 10 shows a graph illustrating the reflectance at various locations about the glass article shown in FIG. 9, across different wavelengths.

FIG. 11 shows microstructure images at various locations about the glass article shown in FIG. 9.

FIG. 12 shows a graph illustrating a surface map of warp measurements for the glass article shown in FIG. 9.

### DETAILED DESCRIPTION OF THE DISCLOSURE

At the outset, it should be appreciated that like drawing numbers on different drawing views identify identical, or functionally similar, structural elements. It is to be understood that the claims are not limited to the disclosed aspects.

Furthermore, it is understood that this disclosure is not limited to the particular methodology, materials and modifications described and as such may, of course, vary. It is also understood that the terminology used herein is for the purpose of describing particular aspects only, and is not intended to limit the scope of the claims.

Unless defined otherwise, all technical and scientific terms used herein have the same meaning as commonly understood to one of ordinary skill in the art to which this disclosure pertains. It should be understood that any methods, devices, or materials similar or equivalent to those described herein can be used in the practice or testing of the example embodiments.

It should be appreciated that the term “substantially” is synonymous with terms such as “nearly,” “very nearly,” “about,” “approximately,” “around,” “bordering on,” “close to,” “essentially,” “in the neighborhood of,” “in the vicinity of,” etc., and such terms may be used interchangeably as appearing in the specification and claims. It should be appreciated that the term “proximate” is synonymous with terms such as “nearby,” “close,” “adjacent,” “neighboring,” “immediate,” “adjoining,” etc., and such terms may be used interchangeably as appearing in the specification and claims. The term “approximately” is intended to mean values within ten percent of the specified value. The term “about” and its synonymous terms mean that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. When the term “about” is used in describing a value or an end-point of a range, the disclosure should be understood to include the specific value or end-point referred to. Whether or not a numerical value or end-point of a range in the specification recites “about,” the numerical value or end-point of a range is intended to include two embodiments: one modified by “about,” and one not modified by “about.” It will be further understood that the end-points of each of the ranges are significant both in relation to the other end-point, and independently of the other end-point.

It should be understood that use of “or” in the present application is with respect to a “non-exclusive” arrangement, unless stated otherwise. For example, when saying that “item x is A or B,” it is understood that this can mean one of the following: (1) item x is only one or the other of A and B: (2) item x is both A and B. Alternately stated, the word “or” is not used to define an “exclusive or” arrangement. For example, an “exclusive or” arrangement for the statement “item x is A or B” would require that x can be only one of A and B. Furthermore, as used herein, “and/or” is intended to mean a grammatical conjunction used to indicate that one or more of the elements or conditions recited may be included or occur. For example, a device comprising a first element, a second element and/or a third element, is intended to be construed as any one of the following structural arrangements: a device comprising a first element: a device comprising a second element: a device comprising a third element: a device comprising a first element and a second element: a device comprising a first element and a third element: a device comprising a first element, a second element and a third element: or, a device comprising a second element and a third element.

Moreover, as used herein, the phrases “comprises at least one of” and “comprising at least one of” in combination with a system or element is intended to mean that the system or element includes one or more of the elements listed after the phrase. For example, a device comprising at least one of: a first element: a second element; and, a third element, is intended to be construed as any one of the following structural arrangements: a device comprising a first element: a device comprising a second element: a device comprising a third element: a device comprising a first element and a second element: a device comprising a first element and a third element: a device comprising a first element, a second element and a third element: or, a device comprising a second element and a third element. A similar interpretation is intended when the phrase “used in at least one of:” is used herein.

Percent (%) transmittance is defined as the percentage of incident light that passes through a thickness of a material. Percent (%) reflectance is defined as the percentage of incident light that is reflected from an interface, as the light propagates from one medium to another, e.g., air to glass. Both % transmittance and % reflectance may also be defined for a system of multiple interfaces, including discontinuous and gradient interfaces. As used herein, % reflectance refers to one-surface reflectance unless indicated otherwise.

Distinctness of image (DOI) is a quantification of the deviation of the direction of light propagation from the regular direction by scattering during transmission or reflection.

Gloss is defined as a measurement, proportional to the amount of light reflected from a surface, determining how shiny a surface appears. Haze causes a drop in reflected contrast and causes halos to appear around light sources: these unwanted effects dramatically reduce visual quality.

Phase separation is defined as the separation of a homogenous medium into two or more distinct homogenous materials, often with different chemistries.

Glass index is defined as the index of refraction of a material.

Coefficient of thermal expansion (CTE) is defined as the coefficient of thermal expansion of a glass composition averaged over a temperature range from about 20° C. to about 300° C.

References herein to the positions of elements (e.g., “top,” “bottom,” “above,” “below,” etc.) are merely used to describe the orientation of various elements in the figures. It should be noted that the orientation of various elements may differ according to other exemplary embodiments, and that such variations are intended to be encompassed by the present disclosure.

Specific and preferred values disclosed for components, ingredients, additives, dimensions, conditions, times, and like aspects, and ranges thereof, are for illustration only; they do not exclude other defined values or other values within defined ranges. The compositions, articles, and methods of the disclosure can include any value or any combination of the values, specific values, more specific values, and preferred values described herein, including explicit or implicit intermediate values and ranges.

Conventional technologies to minimize reflections on glass surfaces include using AR coatings and AR texturing. However, both traditional AR and AG techniques (A) suffer from cost and time limitations (e.g., AR coatings often require multiple coatings of varying compositions): (B) can be difficult to control; and (C) are challenging to jointly optimize (i.e., AR coatings and AG features may cancel the effects of each individually).

In the present disclosure, a new means of using a cladding layer of a laminate glass as an AR/AG surface is described. To achieve this goal, a multi-step process is employed, the initial steps including preheating the glass article followed by simultaneous thermal forming of the glass article and phase separation chemistry of the cladding layer, and etching. Embodiments provide for heat treatment and surface etching cycles to glass articles that enable formation of gradient-index type materials with improved optical performance (e.g., less than 1% total reflectance, greater than 98% total transmittance, lower gloss, and lower DOI on the surface) for a variety of applications such as display applications (e.g., automotive interiors, laptop covers, smartwatches, etc.). Embodiments provide that the laminated structure of the resulting glass is stronger than a single glass system. In some embodiments, at least one of the cladding layer and the core layer, or a combination thereof may be phase-separated at different grain sizes to optimize design for application-specific cover glasses.

Exemplary embodiments of the present disclosure provide a method that simultaneously phase separates and three-dimensionally forms a glass article. In some embodiments, the simultaneous phase separation and three-dimensional (3D) thermal forming of the glass article occurs in a molding press operating at an elevated temperature, wherein the press shapes, and at the same time heat treats, the glass article. In an additional step, once the glass article is shaped and phase-separated, the glass article undergoes an etching process.

Some advantages of the present disclosure include: 1) reducing manufacturing costs by simultaneously performing certain processes: 2) achieving a uniform surface treatment across the entire glass article without significant modification to the equipment or process steps; and, 3) achieving a glass article having an average transmittance (Tx) of greater than 98% and reflectance (Rx) of less than 1% across both surfaces of the article, from the visible to infrared (IR) wavelengths (approximately 400-2200 nm).

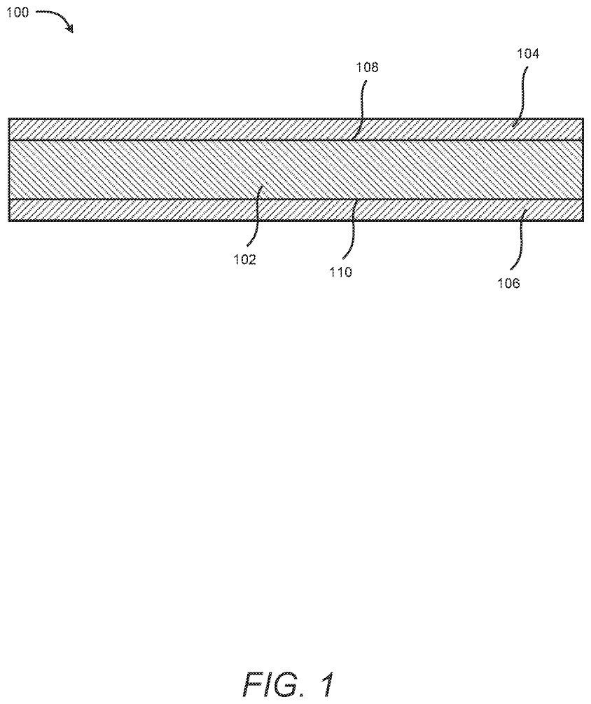

Adverting now to the figures, FIG. 1 is a cross-sectional view of glass article or sheet or substrate 100. In some embodiments, glass sheet 100 comprises a laminated sheet comprising a plurality of glass layers. The laminated sheet can be substantially planar as shown in FIG. 1 or non-planar. Glass sheet 100 comprises core layer 102 disposed between cladding layer 104 and cladding layer 106. In some embodiments, cladding layer 104 and cladding layer 106 are exterior layers as shown in FIG. 1.

Core layer 102 comprises a first major surface 108 and a second major surface 110 opposite the first major surface. In some embodiments, cladding layer 104 is fused to the first major surface 108 of core layer 102. Additionally, or alternatively, cladding layer 106 is fused to the second major surface 110 of core layer 102. In such embodiments, the interfaces between cladding layer 104 and core layer 102 and/or between cladding layer 106 and core layer 102 are free of any bonding material such as, for example, an adhesive, a coating layer, or any non-glass material added or configured to adhere the respective cladding layers to the core layer. Thus, cladding layer 104 and/or cladding layer 106 are fused directly to core layer 102 or are directly adjacent to core layer 102. In some embodiments, glass sheet 100 comprises one or more intermediate layers disposed between core layer 102 and cladding layer 104 and/or between core layer 102 and cladding layer 106. For example, the intermediate layers comprise intermediate glass layers and/or diffusion layers formed at the interface of the core layer and the cladding layer. The diffusion layer can comprise a blended region comprising components of each layer adjacent to the diffusion layer. In some embodiments, glass sheet 100 comprises a glass-glass laminate (e.g., an in situ fused multilayer glass-glass laminate) in which the interfaces between directly adjacent glass layers are glass-glass interfaces.

In some embodiments, the first layer (e.g., core layer 102) comprises a first glass composition, and the second layer (e.g., cladding layer 104 and/or cladding layer 106) comprises a second glass composition that is different than the first glass composition. For example, in the embodiment shown in FIG. 1, core layer 102 comprises the first glass composition, and each of cladding layer 104 and cladding layer 106 comprises the second glass composition. In other embodiments, the first cladding layer comprises the second glass composition, and the second cladding layer comprises a third glass composition that is different than the first glass composition and/or the second glass composition.

The glass sheet can be formed using a suitable process such as, for example, a fusion draw, down draw, slot draw, up draw, or float process. The various layers of the glass sheet can be laminated during forming of the glass sheet or formed independently and subsequently laminated to form the glass sheet. In some embodiments, the glass sheet is formed using a fusion draw process.

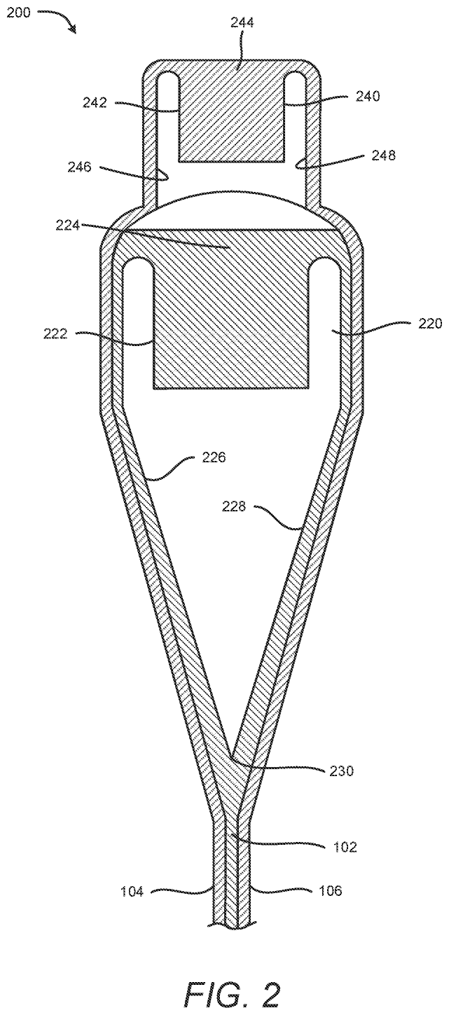

FIG. 2 is a cross-sectional view of one exemplary embodiment of overflow distributor 200 that can be used to form a glass sheet such as, for example, glass sheet 100. Overflow distributor 200 can be configured as described in U.S. Pat. No. 4,214,886 (Corning Incorporated), which is incorporated herein by reference in its entirety. For example, overflow distributor 200 comprises lower overflow distributor 220 and upper overflow distributor 240 positioned above the lower overflow distributor. Lower overflow distributor 220 comprises trough 222. A first glass composition 224 is melted and fed into trough 222 in a viscous state. First glass composition 224 forms core layer 102 of glass sheet 100 as further described below. Upper overflow distributor 240 comprises trough 242. A second glass composition 244 is melted and fed into trough 242 in a viscous state. Second glass composition 244 forms first and second cladding layers 104 and 106 of glass sheet 100 as further described below.

First glass composition 224 overflows trough 222 and flows down opposing outer forming surfaces 226 and 228 of lower overflow distributor 220. Outer forming surfaces 226 and 228 converge at a draw line 230. The separate streams of first glass composition 224 flowing down respective outer forming surfaces 226 and 228 of lower overflow distributor 220 converge at draw line 230 where they are fused together to form core layer 102 of glass sheet 100.

Second glass composition 244 overflows trough 242 and flows down opposing outer forming surfaces 246 and 248 of upper overflow distributor 240. Second glass composition 244 is deflected outward by upper overflow distributor 240 such that the second glass composition flows around lower overflow distributor 220 and contacts first glass composition 224 flowing over outer forming surfaces 226 and 228 of the lower overflow distributor. The separate streams of second glass composition 244 are fused to the respective separate streams of first glass composition 224 flowing down respective outer forming surfaces 226 and 228 of lower overflow distributor 220. Upon convergence of the streams of first glass composition 224 at draw line 230, second glass composition 244 forms first and second cladding layers 104 and 106 of glass sheet 100.

In some embodiments, first glass composition 224 of core layer 102 in the viscous state is contacted with second glass composition 244 of first and second cladding layers 104 and 106 in the viscous state to form the laminated sheet. In some of such embodiments, the laminated sheet is part of a glass ribbon traveling away from draw line 230 of lower overflow distributor 220 as shown in FIG. 2. The glass ribbon can be drawn away from lower overflow distributor 220 by a suitable means including, for example, gravity and/or pulling rollers. The glass ribbon cools as it travels away from lower overflow distributor 220. The glass ribbon is severed to separate the laminated sheet therefrom. Thus, the laminated sheet is cut from the glass ribbon. The glass ribbon can be severed using a suitable technique such as, for example, scoring, bending, thermally shocking, and/or laser cutting. In some embodiments, glass sheet 100 comprises the laminated sheet as shown in FIG. 1. The laminated sheet is processed further (e.g., by cutting or molding) to form and treat glass sheet 100, as will be described in greater detail below.

Although glass sheet 100 shown in FIG. 1 comprises three layers, other embodiments are included in this disclosure. In other embodiments, a glass sheet can have a determined number of layers, such as two, four, or more layers. For example, a glass sheet comprising two layers can be formed using two overflow distributors positioned so that the two layers are joined while traveling away from the respective draw lines of the overflow distributors or using a single overflow distributor with a divided trough so that two glass compositions flow over opposing outer forming surfaces of the overflow distributor and converge at the draw line of the overflow distributor. A glass sheet comprising four or more layers can be formed using additional overflow distributors and/or using overflow distributors with divided troughs. Thus, a glass sheet having a determined number of layers can be formed by modifying the overflow distributor accordingly.

The first and second cladding layers may be any composition that phase separates in a spinodal manner that creates a porous matrix. For example, the first and second cladding layers may be formed from a composition comprising silicon dioxide (SiO₂) having a concentration in a range of 45 wt. % to 75 wt. % (e.g., ˜60 wt. %), alumina (Al₂O₃) having a concentration in a range of 8 wt. % to 19 wt. % (e.g., ˜12 wt. %), boron trioxide (B₂O₃) having a concentration in a range of 5 wt. % to 23 wt. % (e.g., ˜18 wt. %), alkali oxides (e.g., LEO, Na₂O, K₂O, Rb₂O, etc.) having a concentration in a range of 3 wt. % to 21 wt. %, and alkaline earth oxides (e.g., MgO (˜1-5 wt. %), CaO (−1-10 wt. %), SrO (−1-5 wt. %), etc.) having a concentration in a range of 1 wt. % to 15 wt. %. The cladding layers may be substantially free of arsenic (As) and cadmium (Cd) to provide that the degradation rate of the cladding layers is at least ten times greater than the degradation rate of the core layer. In some examples, the cladding layer may be a high B₂O₃-containing aluminosilicate glass.

In some embodiments, cladding layers 104 and 106 are formed from a composition comprising SiO₂ having a concentration of 64.64 wt. %, Al₂O₃ having a concentration of 7.38 wt. %, B₂O₃ having a concentration of 16.45 wt. %, CaO having a concentration of 8.14 wt. %, MgO having a concentration of 2.21 wt. %, SrO having a concentration of 1.11 wt. %, and SnO₂ having a concentration of 0.07 wt. %. In some embodiments, at least one of cladding layer 104 and cladding layer 106 comprises 14-15% Boron.

The core layer may be formed from at least one of an alkaline earth boro-aluminosilicate glass (e.g., CORNING EAGLE XG® glass), CORNING® FOTOFORM glass, CORNING IRIS™ glass, or CORNING GORILLA glass. For example, the core layer may be formed from a glass having a composition of 79.3 wt. % SiO₂, 1.6 wt. % Na₂O, 3.3 wt. % K₂O, 0.9 wt. % KNO₃, 4.2 wt. % Al₂O₃, 1.0 wt. % ZnO, 0.0012 wt. % Au, 0.115 wt. % Ag, 0.015 wt. % CeCE, 0.4 wt. % Sb₂O₃, and 9.4 wt. % LEO. In some examples, the core layer may be formed from a glass composition falling within the ranges as described above for the first and second cladding layers. For example, the core layer may be formed from a glass having a composition of 56.57 wt. % SiO₂, 16.75 wt. % Al₂O₃, 10.27 wt. % B₂O₃, 4.54 wt. % CaO, 3.18 wt. % K₂O, 3.79 wt. % MgO, 4.74 wt. % SrO. In some embodiments, the core layer comprises at least one of CORNING EAGLE XG® glass or CORNING IRIS™ glass, for example, due to their ultra-low auto fluorescence. The core layer provides structural strength to the cladding layer through a stress concentration layer at the core layer/cladding layer interface.

In some embodiments, core layer 102 is formed from a composition comprising SiO₂ having a concentration of 62.4 wt. %, Al₂O₃ having a concentration of 10.89 wt. %, B₂O₃ having a concentration of 9.78 wt. %, CaO having a concentration of 5.37 wt. %, K₂O having a concentration of 2.24 wt. %, MgO having a concentration of 6.23 wt. %, SrO having a concentration of 3.03 wt. %, and SnO₂ having a concentration of 0.07 wt. %. In some embodiments, core layer 102 comprises at least 90% of glass sheet 100.

In some examples, the core layer may be formed from glass compositions which have an average CTE of greater than or equal to about 40×10⁻⁷/° C. in a range from 20° C. to 300° C. In some examples, the average CTE of the glass composition of the core layer may be greater than or equal to about 60×10⁻⁷/° C. in a range from 20° C. to 300° C. In some examples, the average CTE of the glass composition of the core layer may be greater than or equal to about 80×10⁻⁷/° C. averaged over a range from 20° C. to 300° C. In some examples, the first and second cladding layers have an average CTE different from the average CTE of the core layer. In some examples, the first and second cladding layers have an average CTE lower than the average CTE of the core layer. In some examples, the first and second cladding layers have an average CTE higher than the average CTE of the core layer. In some embodiments described herein, the glass cladding layers are formed from clad glass compositions which have average CTEs less than or equal to about 40×10⁻⁷/° C. averaged over a range from 20° C. to 300° C. In some embodiments, the average CTE of the clad glass compositions may be less than or equal to about 37×10⁻⁷/° C. averaged over a range from 20° C. to 300° C. In yet other embodiments, the average CTE of the clad glass compositions may be less than or equal to about 35×10⁻⁷/° C. averaged over a range from 20° C. to 300° C.

In some embodiments, the glass composition of core layer 102 and cladding layers 104 and 106 comprise softening points that are substantially similar. For example, it is desirable for the thermal forming temperature and the phase separation temperature to be similar (e.g., approximately 750° C.). This reduces the total time needed for a single thermal forming and phase separation step to occur. In some embodiments, the glass composition of core layer 102 comprises a lower softening point than the glass composition of cladding layers 106 and 106. Such different softening points can enable forming of glass sheet 100 into a shaped glass article while avoiding potentially detrimental surface interaction between the glass sheet and the forming surface as described herein.

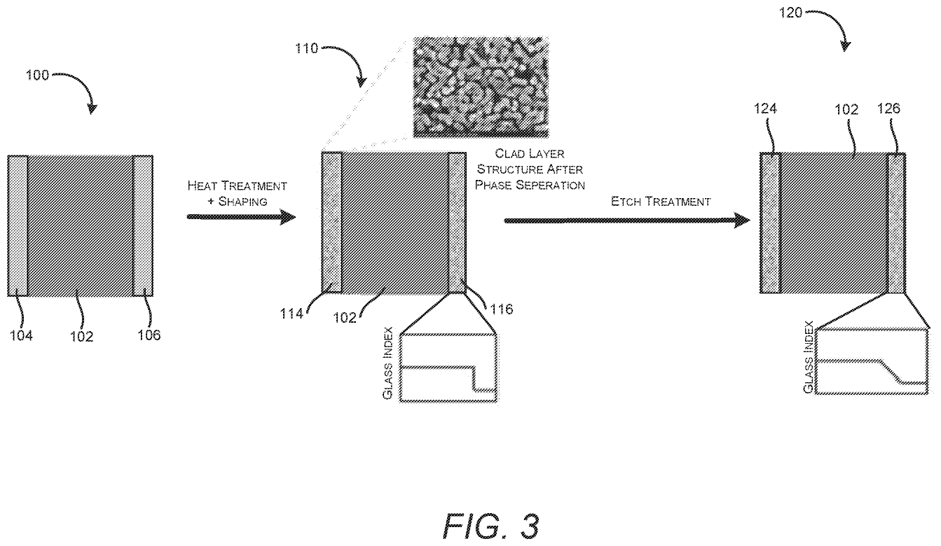

FIG. 3 illustrates a fusion-drawn laminated glass treatment process. Slope change of the glass index indicates a gradient-index effect on the surface, which is responsible for minimization of Fresnel reflections on the surface. The initial, fusion-drawn glass laminate is equivalent to glass article 100 described in FIG. 1 above having at least one amorphous cladding layer (cladding layer 104 and/or 106) and an amorphous core layer 102. In a first step, the glass article 100 undergoes a series of heating treatments in which the glass article is heated at a certain temperature for a prescribed time period. Second, the glass article 100 is simultaneously heat treated and thermal formed transforming glass article 100 into 3D shaped glass article 110 including phase-separated cladding layers 114 and 116. It should be appreciated that embodiments include the second step of simultaneous heating and thermal forming can include heat treating and applying a pressure at multiple levels for numerous periods of time. In a third step, etching transforms glass article 110 into glass article 120 including cladding layers 124 and 126. The etch treatment applied removes one of the two phases of cladding layers 114 and 116, leaving behind porous cladding layers 124 and 126.

### Step 1—Preheating

The preheating step can be performed in a high temperature forming press or a heating oven that is operable to maintain the glass article and apply heat to the glass article. In this step the glass article is subjected to one or more temperature levels for predetermined period of time such that the glass article's temperature is raised to a temperature that is relatively close and below the phase separation temperature of the glass article.

### Step 2—Simultaneous Heat Treatment and Thermal Forming

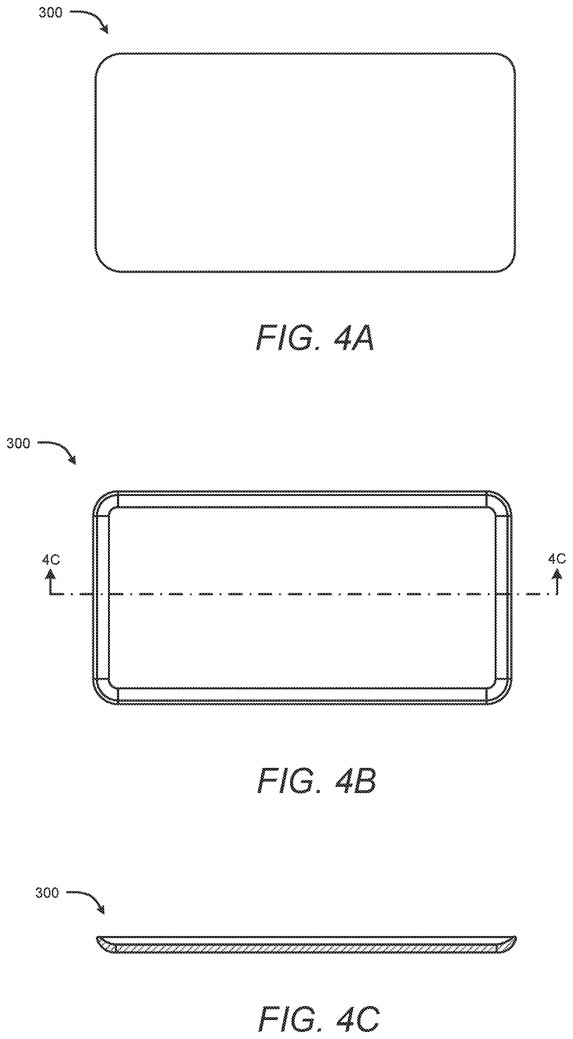

The heat treatment and forming step is performed in a high temperature forming press. In some embodiments, the press comprises nine zones and operates in an inert atmosphere, and uses pre-formed graphite molds. FIG. 4A shows preform 300 prior to forming (i.e., before the heat treatment and forming step). FIGS. 4B-C show preform 300 after forming, wherein the heat treatment and forming step was used to form/shape preform 300 into a 3D shape. In some embodiments, the press includes one or more of the following specifications: 1) 1° C. temperature control: 2) a maximum mold size of 120×180×25-50 mm: 3) a maximum forming temperature of 850° C.: 4) a positive pressure range of 0.001-0.9 MPa; and, 5) sequenced heating, pressing, and cooling capability.

In some embodiments, the simultaneous heat treatment and thermal forming step comprises the following recipe, with each zone having a set temperature and time spent per sample, and an applied pressure. The first four zones in the press are dedicated to heating glass article 100, and are used to bring glass article 100 to a phase separating temperature (e.g., 750° C.). The subsequent three zones are used for thermal forming, where a pressure is applied to glass article 100 for it to take shape, and simultaneous phase separation of glass article 100, specifically, cladding layers 104 and 106. In some embodiments, glass article 100 is heated to a temperature of greater than or equal to the glass transition temperature T_{g} of cladding layers 104 and/or 106. The glass transition temperature T_{g} is the temperature at which a glass transforms from an elastic to a viscoelastic material relative to increasing temperature, characterized by the onset of a rapid change in thermal expansivity, as is known in the art. In some embodiments, glass article 100 is heated to a temperature of greater than or equal to the glass transition temperature T_{g} and less than or equal to the softening point Tₛ of cladding layers 104 and 106 (e.g., 500-1,000 degrees Celsius). The softening point or Littleton softening point Tₛ of glass is the temperature at which the glass moves under its own weight, as is known in the art. In embodiments, the softening point is determined as per ASTM C338-93 (2019) Standard Test Method for Softening Point of Glass. In some embodiments, glass article 100 is heated to a temperature at which cladding layers 104 and 106 spinodally phase separate. In some embodiments, glass article 100 spends a total of 20 min at 750° C. The subsequent zones (e.g., two zones) are used to cool the glass article and reduce the forming pressure. Thus, glass article 100 is transformed into glass article 110, which includes phase-separated cladding layers 114 and 116 and a 3D shape, in the same step. In some embodiments, the total process time for the simultaneous phase separation and 3D shaping step is approximately 30 min.

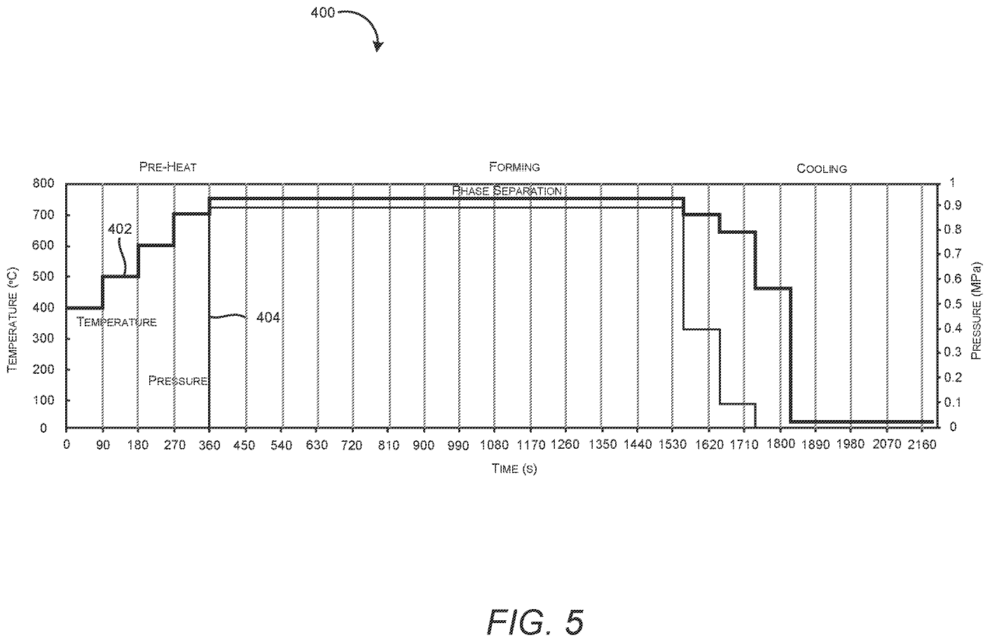

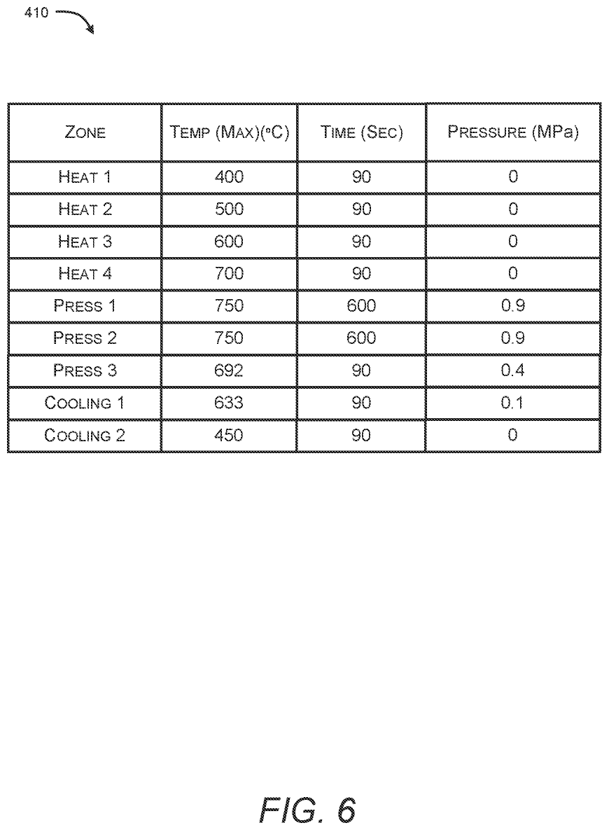

An example embodiment of Steps 1-2 of the present disclosure is illustrated in FIGS. 5-6. FIG. 5 shows graph 400 of the process of Steps 1-2, wherein line 402 represents temperature of the press and line 404 represents pressure of the press. FIG. 6 shows chart 410 including data related to the graph shown in FIG. 5. Steps 1-2 of the present disclosure can be broken down into nine steps or zones as follows. It should be appreciated that embodiments of the present disclosure provide that the time periods set in FIG. 6 are representative of a minimum time period and that embodiments include longer time periods for each zone or step to still obtain the final end result glass article.

In a first zone or step, the press applies a temperature of 400° C. to glass article 100 for 90 seconds. No pressure is applied to glass article 100 in the first zone. In some embodiments, in the first zone, glass article 100 is heated to 400° C.

In a second zone or step, the press applies a temperature of 500° C. to glass article 100 for 90 seconds. No pressure is applied to glass article 100 in the second zone. In some embodiments, in the second zone, glass article 100 is heated to 500° C.

In a third zone or step, the press applies a temperature of 600° C. to glass article 100 for 90 seconds. No pressure is applied to glass article 100 in the third zone. In some embodiments, in the third zone, glass article 100 is heated to 600° C.

In a fourth zone or step, the press applies a temperature of 700° C. to glass article 100 for 90 seconds. No pressure is applied to glass article 100 in the fourth zone. In some embodiments, in the fourth zone, glass article 100 is heated to 700° C.

In a fifth zone or step, the press applies a temperature of 750° C. and a pressure of 0.9 MPa to glass article 100 for 600 seconds. In some embodiments, in the fifth zone, glass article 100 is heated to 750° C. It should be appreciated that the press applies pressure to glass article 100 such that it engages a pre-form mold (e.g., mold 300) to shape glass article 100. Moreover, in some embodiments, phase separation of cladding layers 104 and 106 begins to occur at approximately 710° C. It should be appreciated that embodiments include effecting heat transfer during the heating process of the press through contact of the press with glass article 100 (i.e., zones 5-7).

In a sixth zone or step, the press applies a temperature of 750° C. and a pressure of 0.9 MPa to glass article 100 for 600 seconds. In some embodiments, in the sixth zone, glass article 100 is heated to 750° C. In some embodiments, the fifth and the sixth zones are combined such that the press applies a temperature of 750° C. and a pressure of 0.9 MPa to glass article 100 for 1200 seconds.

In a seventh zone or step, the press applies a temperature of 692° C. and a pressure of 0.4 MPa to glass article 100 for 90 seconds. In some embodiments, in the seventh zone, glass article 100 is cooled to 692° C.

In an eighth zone or step, the press applies a temperature of 633° C. and a pressure of 0.1 MPa to glass article 100 for 90 seconds. In some embodiments, in the eighth zone, glass article 100 is cooled to 633° C.

In a ninth zone or step, the press applies a temperature of 450° C. to glass article 100 for 90 seconds. No pressure is applied to glass article 100 in the ninth zone. In some embodiments, in the eighth zone, glass article 100 is cooled to 633° C. During testing of the method of the present disclosure, it was discovered that zones 7-9 stop the phase separation process (i.e., bring cladding layers out of phase separation) and set the shape of the glass article. This is due to the gradual cooling and pressure release.

Following the ninth zone, it is said that glass article 100 has been transformed into shaped and phase-separated glass article 110. Glass article 110 can then enter into an etch treatment step, wherein the phase-separated cladding layers 114 and 116 and core layer 102 are subjected to a liquid or vapor etching.

Embodiments of the present disclosure provide that during the steps 5-7, the glass article, and specifically cladding layers 104 and 106, undergoes spinodal phase separation on a nano scale. Such spinodal phase separation transforms the single phase cladding layers 104 and 106 to two-phase cladding layers 114 and 116. This allows the etch treatment (described below) to eat away one of the two phases such that cladding layers 114 and 116 are porous and exhibit better AG and/or AR characteristics. At the same time as the spinodal phase separation, glass article 100 is thermal formed and takes its desired shape.

### Step 3—Etch Treatment

In some embodiments, the etch treatment may be conducted as follows. Two volume percent (2 vol. %) hydrogen fluoride (HF) solution was prepared. Glass article 110 is taped off on one side to perform a one-sided etch. Glass article 110 is etched in a volume of HF solution for a length of time, for example, 90 seconds. Glass article 110 is then dipped in a H₂O bath for a length of time, for example 120 seconds. Glass article 110 is then rinsed in deionized (DI) water, and dried and cleaned with N₂. Following this etching treatment, it is said that glass article 110 has been transformed into glass article 120, wherein the etching process removed one of the two phases of cladding layers 114 and 116, leaving behind single phase porous cladding layers 124 and 126.

In some embodiments, a wet chemical etch is conducted using a suitable component capable of degrading or dissolving the glass article. For example, the suitable wet etching chemical includes an acid (e g., HCl, HNO₃, H₂SO₄, H₃PO₄, H₃BO₃, HBr, HClO₄, HF, acetic acid, citric acid, NH₄F, ammonium bifluoride acid), a base (e.g., LiOH, NaOH, KOH, RbOH, CsOH, Ca(OH)₂, Sr(OH)₂, Ba(OH)₂), H2O, or a combination thereof. In some examples, the wet chemical etchant has a concentration in a range of 0.1 vol. % to 10 vol. %, or 0.2 vol. % to 9 vol. %, or 0.3 vol. % to 8 vol. %, or 0.4 vol. % to 7 vol. %, or 0.5 vol. % to 6 vol. %, or 0.6 vol. % to 5 vol. %, or 0.25 vol. % to 5 vol. %, or 0.25 vol. % to 3 vol. %, or 0.25 vol. % to 2 vol. %, or any intervening value or range disclosed therein.

In some embodiments, the wet chemical etchant has a concentration of 0.1 vol. %, or 0.15 vol. %, or 0.2 vol. %, or 0.25 vol. %, or 0.3 vol. %, or 0.35 vol. %, or 0.4 vol. %, or 0.45 vol. %, or 0.5 vol. %, or 0.55 vol. %, or 0.6 vol. %, or 0.65 vol. %, or 0.7 vol. %, or 0.75 vol. %, or 0.8 vol. %, or 0.85 vol. %, or 0.9 vol. %, or 0.95 vol. %, or 1 vol. %, or 1.1 vol. %, or 1.2 vol. %, or 1.3 vol. %, or 1.4 vol. %, or 1.5 vol. %, or 1.6 vol. %, or 1.7 vol. %, or 1.8 vol. %, or 1.9 vol. %, or 2 vol. %, or 2.25 vol. %, or 2.5 vol. %, or 3 vol. %, or 3.5 vol. %, or 4 vol. %, or 4.5 vol. %, or 5 vol. %, or 6 vol. %, or 7 vol. %, or 8 vol. %, or 9 vol. %, or 10 vol. %, or any intervening value disclosed therein.

In some embodiments, a dry etch process is conducted comprising at least one of ion beam etching, plasma etching, reactive ion etching, or combinations thereof, using suitable gases therein such as oxygen-, nitrogen-, halogen-, or fluorine-containing, or a combination thereof.

In some embodiments, the etch treatment may be conducted at a time in a range of 1 sec to 24 hrs, 5 sec to 20 hrs, 10 sec to 16 hrs, 20 sec to 12 hrs, 30 sec to 8 hrs, 45 sec to 4 hrs, or any intervening value or range disclosed therein. In some examples, the etch treatment may be conducted at a time in a range of 1 sec to 300 sec, or 5 sec to 250 sec, or 10 sec to 200 sec, or 20 sec to 150 sec, or 10 sec to 120 sec, or 20 sec to 120 sec, or 30 sec to 120 sec, or 45 sec to 120 sec, or 60 sec to 120 sec, or 90 sec to 120 sec, or any intervening value or range disclosed therein. In some examples, the etch treatment may be conducted at a time of 1 sec, or 5 sec, or 10 sec, or 20 sec, or 30 sec, or 45 sec, or 60 sec, or 75 sec, or 90 sec, or 105 sec, or 120 sec, or 150 sec, or 180 sec, or 210 sec, or 240 sec, or 270 sec, or 300 sec, 4 hrs, or 8 hrs, or 12 hrs, or 16 hrs, or 20 hrs, or 24 hrs, or any intervening value disclosed therein.

In some embodiments, any etchant is selected independently of any time or time range and concentration or concentration range. For example, the etch treatment may be conducted as a wet chemical etch using 0.5 vol. % HF, etc.

Thus, in Step 3 after the simultaneous shaping and phase separation, glass samples are etched to form porous surface structures with channel widths determined by the size of silica-poor phase regions and heat-treatment conditions. In other words, the etch treatment produces a graded glass index on the order of greater than 5 nm (e.g., 50 nm) or 1 nm to 100 nm, or 100 nm to 1 micron, or 1 micron to 5 microns by removal of boron or other elements near the clad glass/air interface.

By the etch treatment described herein, the boron-rich phase is removed. So as long as phase separation creates two phases where one etches at a preferentially higher or lower rate, the etch treatment may be able to preferentially target specific elements of the cladding composition. However, preferential etching is glass dependent. For example, in borosilicate glasses, typically the boron matrix etches faster than the silicate matrix. In other systems without boron (e.g., aluminosilicate glass), phase separation occurs specific to their unique chemistries.

The average pore size and porosity of the porous regions may be altered by controlling the heat treatment through which phase separation occurs and the etching treatment by which a second phase is removed from discrete dispersed regions. In addition, using a strong etchant, or etching for an extended period of time may also slightly increase the pore size. The average pore size and porosity of the porous regions may, in embodiments, effect the reflectance and refraction of light of the shaped glass laminated article, thereby providing an anti-reflective and/or refractive effect on the shaped glass laminated article. Moreover, controlling the thickness of the porous region in a laminated glass article, such as by controlling the heat treatment and etching treatment as described above, may result in reduced reflectance across visible and IR wavelengths.

The porous region (or regions) described herein has antireflective properties that is effected, in part, from average pore size of the porous region. Accordingly, in some embodiments the average pore size of the porous region is greater than or equal to 10 nm and less than or equal to 200 nm, such as greater than or equal to 25 nm and less than or equal to 200 nm, greater than or equal to 50 nm and less than or equal to 200 nm, greater than or equal to 75 nm and less than or equal to 200 nm, greater than or equal to 100 nm and less than or equal to 200 nm, greater than or equal to 125 nm and less than or equal to 200 nm, greater than or equal to 150 nm and less than or equal to 200 nm, greater than or equal to 175 nm and less than or equal to 200 nm, greater than or equal to 10 nm and less than or equal to 175 nm, greater than or equal to 25 nm and less than or equal to 175 nm, greater than or equal to 50 nm and less than or equal to 175 nm, greater than or equal to 75 nm and less than or equal to 175 nm, greater than or equal to 100 nm and less than or equal to 175 nm, greater than or equal to 125 nm and less than or equal to 175 nm, greater than or equal to 150 nm and less than or equal to 175 nm, greater than or equal to 10 nm and less than or equal to 150 nm, greater than or equal to 25 nm and less than or equal to 150 nm, greater than or equal to 50 nm and less than or equal to 150 nm, greater than or equal to 75 nm and less than or equal to 150 nm, greater than or equal to 100 nm and less than or equal to 150 nm, greater than or equal to 125 nm and less than or equal to 150 nm, greater than or equal to 10 nm and less than or equal to 125 nm, greater than or equal to 25 nm and less than or equal to 125 nm, greater than or equal to 50 nm and less than or equal to 125 nm, greater than or equal to 75 nm and less than or equal to 125 nm, greater than or equal to 100 nm and less than or equal to 125 nm, greater than or equal to 10 nm and less than or equal to 100 nm, greater than or equal to 25 nm and less than or equal to 100 nm, greater than or equal to 50 nm and less than or equal to 100 nm, greater than or equal to 75 nm and less than or equal to 100 nm, greater than or equal to 10 nm and less than or equal to 75 nm, greater than or equal to 25 nm and less than or equal to 75 nm, greater than or equal to 50 nm and less than or equal to 75 nm, greater than or equal to 10 nm and less than or equal to 50 nm, greater than or equal to 25 nm and less than or equal to 50 nm, or greater than or equal to 10 nm and less than or equal to 25 nm.

In some embodiments, the porous regions comprise a thickness of greater than or equal to about 50 nm and less than or equal to about 450 nm. In some embodiments, porous regions with a thickness greater than or equal to 350 nm and less than or equal to 450 nm showed the above-described reflective effects, such as porous regions with a thickness greater than or equal to 360 nm and less than or equal to 450 nm, greater than or equal to 370 nm and less than or equal to 450 nm, greater than or equal to 380 nm and less than or equal to 450 nm, greater than or equal to 390 nm and less than or equal to 450 nm, greater than or equal to 400 nm and less than or equal to 450 nm, greater than or equal to 410 nm and less than or equal to 450 nm, greater than or equal to 420 nm and less than or equal to 450 nm, greater than or equal to 430 nm and less than or equal to 450 nm, greater than or equal to 440 nm and less than or equal to 450 nm, greater than or equal to 350 nm and less than or equal to 440 nm, greater than or equal to 350 nm and less than or equal to 430 nm, greater than or equal to 350 nm and less than or equal to 420 nm, greater than or equal to 350 nm and less than or equal to 410 nm, greater than or equal to 350 nm and less than or equal to 400 nm, greater than or equal to 350 nm and less than or equal to 390 nm, greater than or equal to 350 nm and less than or equal to 380 nm, greater than or equal to 350 nm and less than or equal to 370 nm, or greater than or equal to 350 nm and less than or equal to 360 nm. In some embodiments, the porous regions comprise a thickness of greater than or equal to 200 nm and less than or equal to 350 nm. In some embodiments, the porous regions comprise a thickness of greater than or equal to about 50 nm and less than or equal to about 180 nm, for example, a thickness ranging from 129.5-156.3 nm, 134.0-136.2 nm, or 96.25-125.1.

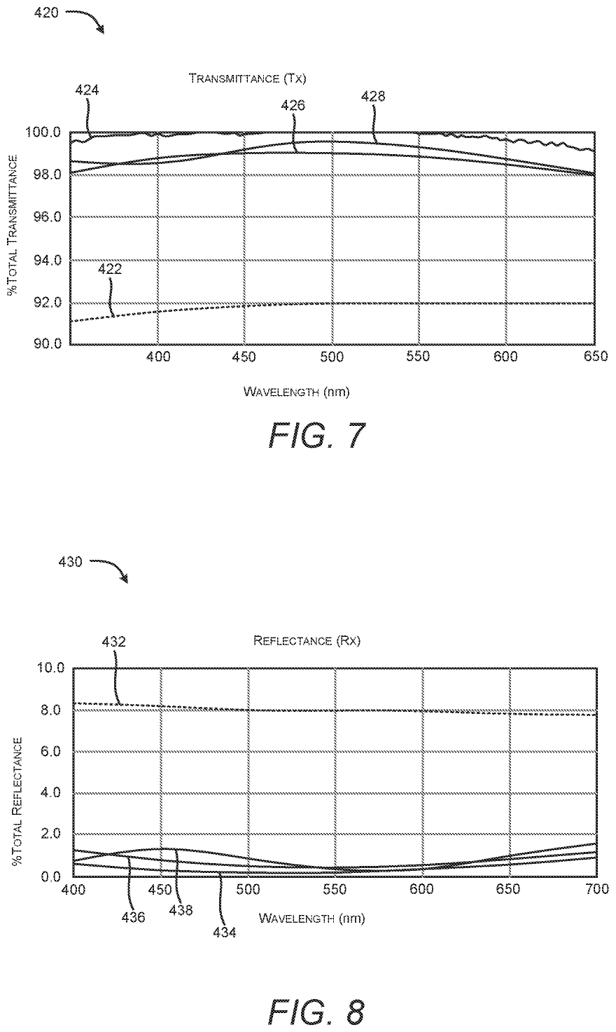

FIG. 7 shows graph 420 illustrating the transmittance for glass articles formed by various methods across different wavelengths. Line 422 represents a control sample obtains from the fusion draw (i.e., glass article 100). Line 424 represents samples heat treated in a traditional box or Lehr furnace and etched, but not yet shaped. Line 426 represents samples that are simultaneously heat-treated and formed in the thermal press, and etched as described in the present disclosure. Line 428 represents samples that are heat treated in a box or Lehr furnace, subsequently formed in a thermal press, and finally etched.

FIG. 8 shows graph 430 illustrating the reflectance for glass articles formed by various methods across different wavelengths. Line 432 represents a control sample obtains from the fusion draw (i.e., glass article 100). Line 434 represents samples heat treated in a traditional box or Lehr furnace and etched, but not yet shaped. Line 436 represents samples that are simultaneously heat-treated and formed in the thermal press, and etched as described in the present disclosure. Line 438 represents samples that are heat treated in a box or Lehr furnace, subsequently formed in a thermal press, and finally etched.

It should be appreciated that measurements in FIGS. 7-8 were taken at the center of each specimen. The average transmittance of the samples made according to the method of the present disclosure (i.e., the simultaneous 3D thermal forming and phase separation of the glass article), indicated by line 426, is greater than 98%, just slightly lower than the reference unshaped treated samples indicated by line 424. Whereas the average reflectance of the samples made according to the method of the present disclosure (i.e., the simultaneous 3D thermal forming and phase separation of the glass article), indicated by line 426, is less than 1%, similar to the reference unshaped treated samples indicated by line 424.

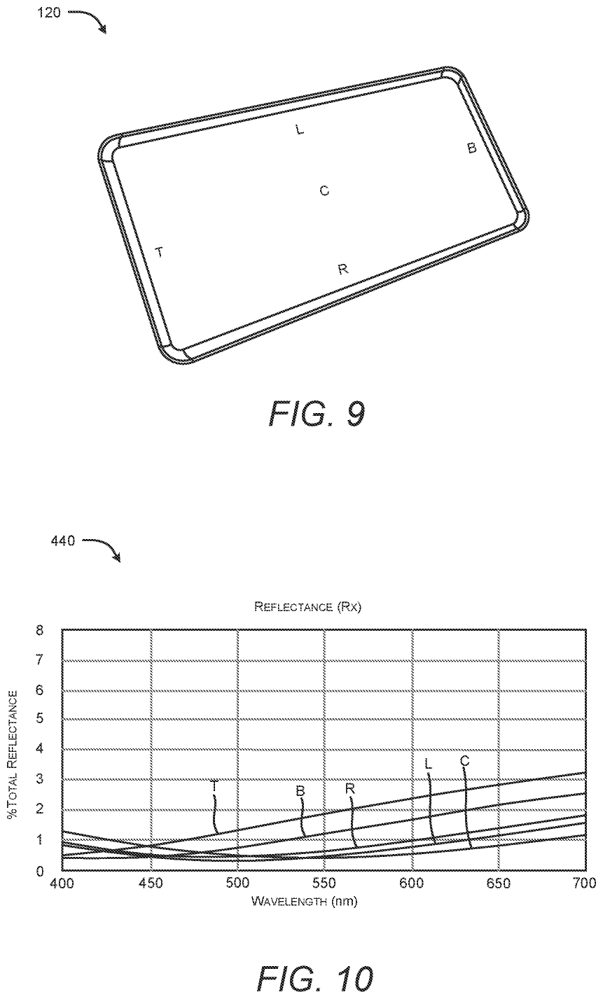

FIG. 9 is a perspective view of glass article 120, which as previously described was formed by the method of the present disclosure. Measurements were taken at reference points L, T, C, B, and R, as shown on glass article 120, wherein C is the geometric centroid of glass article 120. The distance between point C and point L is about 30 mm. The distance between point C and point R is about 30 mm. The distance between point C and point T is about 65 mm. The distance between point C and point B is about 65 mm. FIG. 10 shows a graph illustrating the reflectance at various locations about glass article 120, as shown in FIG. 9, across different wavelengths. For example, line L represents the reflectance at position L of glass article 120 across various wavelengths. Line T represents the reflectance at position T of glass article 120 across various wavelengths. Line C represents the reflectance at position C of glass article 120 across various wavelengths. Line B represents the reflectance at position B of glass article 120 across various wavelengths. Line R represents the reflectance at position R of glass article 120 across various wavelengths. As depicted in graph 440, the locations labeled C, R, and L are similar in reflectance measurements, whereas the locations labeled T and B have larger variation than the center of the glass article 120.

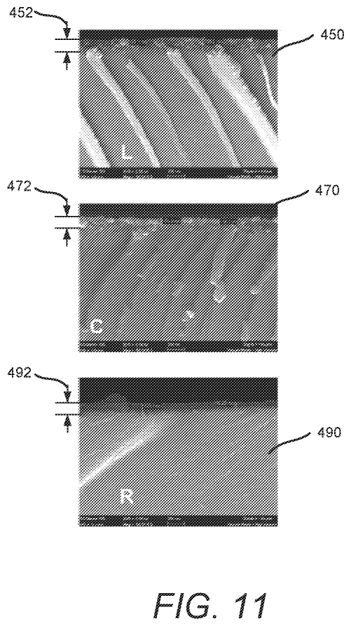

FIG. 11 shows microstructure images, taken using a scanning electron microscope (SEM), at the various locations about glass article 120 shown in FIG. 9. Image 450 shows region L with surface treatment layer 452 being approximately 129.5-156.3 nm. Image 470 shows region C with surface treatment layer 472 being approximately 134.0-136.2 nm. Image 490 shows region R with surface treatment layer 492 being approximately 96.25-125.1 nm. As such, regions C, R, and L had a surface treatment layer of approximately 125 nm. Assuming a mean of 125 nm, glass article 120 comprises a percent deviation of less than 12 percent, for example, about 11.31 percent, across regions C, R, and L, wherein percent deviation is calculated using the following steps: 1) calculate the deviation of each point according to the equation

$$D = \vert d - m \vert$$

wherein D is the average deviation, d is the data point's value, m is the mean (e.g., 125 nm), and ∥ represents the absolute value: 2) calculate the average of the deviations calculated in step 1): 3) divide the average calculated in step 2) by the mean (e.g., 125 nm) and multiply by 100.

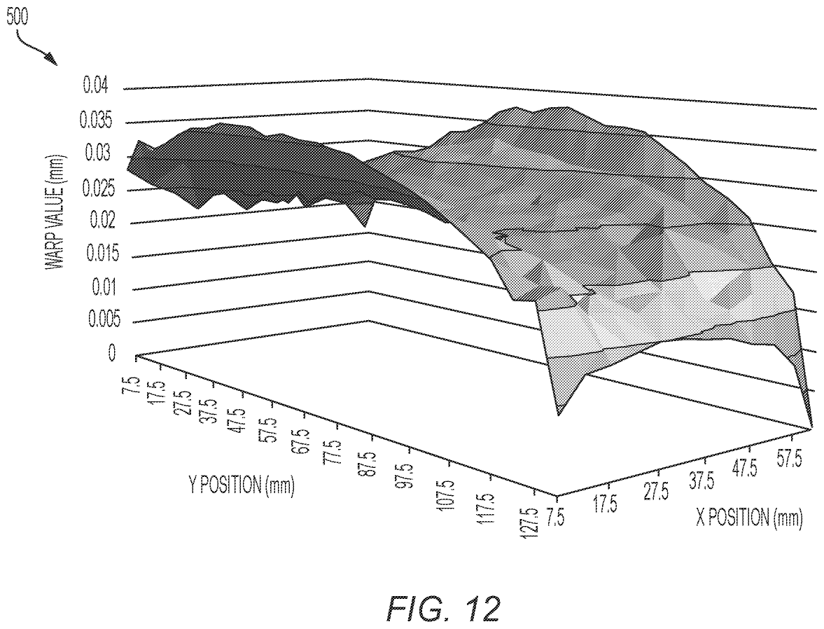

FIG. 12 shows graph 500 illustrating a surface map of warp measurements for glass article 120 shown in FIG. 9. The central area of glass article 120 is intended to be flat. To check the level of flatness after the simultaneous 3D thermal forming and phase separation step, the concave side of the central area was measured for warp, with the parameters being 7.5 mm inboard from all edges and spacing between each measurement of 5 mm. Glass article 120 was not able to be measured on its opposing side due to the nature of the gauge and the shape of the part. The resulting maximum warp value reported (i.e., the difference between the highest point of the surface and the lowest point of the surface) was 0.038 mm, which is considered to be a low maximum warp value and thus a desirable result.

This disclosure has been described in detail with particular reference to an embodiment, but it will be understood that variations and modifications can be effected within the spirit and scope of the disclosure. The presently disclosed embodiments are therefore considered in all respects to be illustrative and not restrictive. The scope of the disclosure is indicated by the appended claims, and all changes that come within the meaning and range of equivalents thereof are intended to be embraced therein.

1. A method of forming a shaped glass laminate, comprising:
preheating a substrate including a core layer and at least one cladding layer, the at least one cladding layer comprising a phase-separable glass composition;
simultaneously heat treating and thermal forming the substrate such that the at least one cladding layer is phase-separated and at least a portion of the substrate is deformed to form the shaped glass laminate, the simultaneous heat treating and thermal forming of the substrate including heating the substrate and pressing the substrate at the same time; and
etch treating the substrate.

2. The method as recited in claim 1, wherein the step of simultaneously heat treating and thermal forming the substrate further comprises:
cooling the substrate.

3. The method as recited in claim 1, wherein the step of preheating the substrate comprises:
heating the substrate to a temperature of less than a glass transition temperature of the at least one cladding layer.

4. The method as recited in claim 1, wherein the step of preheating the substrate comprises heating the substrate using a plurality of preheat stages, each preheat stage comprising a preheat temperature range and preheat hold time.

5. The method as recited in claim 1, wherein the step of simultaneously heat treating and thermal forming the substrate comprises:
heating the substrate to a temperature ranging from a glass transition temperature of the at least one cladding layer to a softening point of the at least one cladding layer; and
applying a pressure of at least 0.9 MPa to the substrate.

6. The method as recited in claim 1, wherein the step of simultaneously heat treating and thermal forming the substrate comprises:
simultaneously heating the substrate to about 750° C. and applying a pressure of about 0.9 MPa to the substrate for at least 600 seconds.

7. (canceled)

8. The method as recited in claim 1, wherein the step of simultaneously heat treating and thermal forming the substrate comprises:
simultaneously heating the substrate at a temperature of greater than or equal to about 710° C. and contacting the substrate with a forming surface at a pressure ranging between 0.1 MPa to 0.9 MPa.

9. The method as recited in claim 1, wherein the step of simultaneously heat treating and thermal forming the substrate comprises:
simultaneously heating the substrate to a temperature at which spinodal phase separation of the at least one cladding layer occurs and contacting the substrate with a forming surface at a pressure at which deformation of the substrate occurs.

10. (canceled)

11. The method as recited in claim 2, wherein the step of cooling the substrate comprises:
cooling the substrate using a plurality of cooling stages, each cooling stage comprising a cooling temperature range, a pressure, and a cooling hold time.

12. The method as recited in claim 1, wherein the step of etch treating the substrate comprises:
applying a solution of at least 2% vol. hydrogen fluoride (HF) to the substrate for at least 90 seconds;
submerging the substrate in a dihydrogen monoxide (H₂O) bath for at least 120 seconds;
rinsing the substrate in deionized water; and
cleaning the substrate with dinitrogen (N₂).

13. A method of forming a phase-separated glass laminate having improved anti-reflection (AR) and anti-glare (AG) characteristics, the method comprising:
providing a substrate including a core layer and at least one cladding layer fused with the core layer;
simultaneously heat treating and forming the substrate, using a thermal press, by:
heating the substrate to a temperature at which spinodal phase separation of the at least one cladding layer occurs; and
pressing the substrate onto a forming surface; and
etch treating the substrate.

14. The method as recited in claim 13, wherein the step of heating the substrate to a temperature at which spinodal phase separation of the at least one cladding layer occurs comprises:
heating the substrate to a temperature ranging from a glass transition temperature of the at least one cladding layer to a softening point of the at least one cladding layer for at least 1200 seconds.

15. The method as recited in claim 13, wherein the step of pressing the substrate onto the forming surface comprises:
arranging the substrate on a pre-form mold;
applying a first pressure to the substrate of at least 0.9 MPa for at least 1200 seconds; and
reducing the first pressure applied to the substrate from 0.9 MPa to a second pressure ranging between 0.1 MPa to 0.4 MPa.

16. (canceled)

17. The method as recited in claim 13, further comprising, prior to the step of simultaneously heat treating and forming the substrate:
preheating the substrate to a temperature of less than a glass transition temperature of the at least one cladding layer.

18. (canceled)

19. (canceled)

20. (canceled)

21. (canceled)

22. (canceled)

23. (canceled)

24. (canceled)

25. (canceled)

26. (canceled)

27. (canceled)

28. A shaped glass laminate article comprising:
a core layer;
at least one cladding layer fused or laminated to the core layer, the at least one cladding layer including a porous region at an outer surface thereof, the core layer and the at least one cladding layer being deformed to form the shaped glass laminate, wherein:
the shaped glass laminate article has a transmittance across an entire spectrum from about 400 nm to about 2200 nm that is greater than or equal to 97%; and
the shaped glass laminate article has a reflectance across an entire spectrum from 400 nm to 2200 nm that is less than or equal to 3% at the outer surface.

29. The shaped glass laminate article as recited in claim 28, wherein the shaped glass laminate article has a transmittance across the entire visible spectrum from about 400 nm to about 2200 nm that is greater than 98%.

30. The shaped glass laminate article as recited in claim 28, wherein the shaped glass laminate article has a reflectance across the entire visible spectrum from about 400 nm to about 2200 nm that is less than 1%.

31. The shaped glass laminate article as recited in claim 28, wherein the porous region has an average pore size that is greater than or equal to 10 nm and less than or equal to 200 nm.

32. The shaped glass laminate article as recited in claim 28, wherein the porous region has a porosity that is greater than or equal 0.16 and less than or equal to 0.22.

33. The shaped glass laminate article as recited in claim 28, wherein a thickness of the porous region one or more of (i) is greater than or equal to 350 nm and less than or equal to 450 nm and (ii) has a percent deviation of less than 12 percent.

34. (canceled)
